(19) United States
(12) Patent Application Publication
(10) Pub. No.: US 2018/0032579 A1
(43) Pub. Date: Feb. 1, 2018

(54) NON-TRANSITORY COMPUTER-READABLE RECORDING MEDIUM, DATA SEARCH METHOD, AND DATA SEARCH DEVICE

(71) Applicant: FUJITSU LIMITED, Kawasaki-shi (JP)

(72) Inventors: Daisuke Higuchi, Kobe (JP); MASAKI NISHIGAKI, Kobe (JP)

(73) Assignee: FUJITSU LIMITED, Kawasaki-shi (JP)

(21) Appl. No.: 15/631,200

(22) Filed: Jun. 23, 2017

(30) Foreign Application Priority Data
Jul. 28, 2016 (JP) 2016-148562

(51) Int. Cl. G06F 17/30

(52) U.S. Cl. CPC G06F 17/30489; G06F 17/30469; G06F 17/30442; G06F 17/30424; G06F 17/30598

(57) ABSTRACT

A data search device specifies a first cluster that is closest to an input query, specifies another cluster that is different from the first cluster that includes the target data and whose distance from the input query is within the first distance, by using a first distance indicating a distance from the position of the input query to the center of the first cluster, extracts the target data that belongs to the other cluster and whose distance from the input query is within the first distance or the target data that belongs to the other cluster and whose distance from the center of the other cluster is greater than a second distance and searches the target data similar to the input query from the target data that belongs to the first cluster and the target data that is extracted from the other cluster.

### CROSS-REFERENCE TO RELATED APPLICATION

This application is based upon and claims the benefit of priority of the prior Japanese Patent Application No. 2016-148562, filed on Jul. 28, 2016, the entire contents of which are incorporated herein by reference.

### FIELD

The embodiment discussed herein is related to a computer-readable recording medium, and the like.

### BACKGROUND

In recent years, there is a similarity search process, such as image search, voice search, or the like, that searches for data similar to a query from enormous amount of unstructured data in a database and outputs the data to be searched. In the similarity search process, the processing time is increased because 1) an amount of searched target data is enormous, 2) an amount of data is daily increased, 3) an amount of individual data is large, and the like. Consequently, there is a need to speed up the similarity search process.

A description will be given of an example of a conventional technology that speeds up the similarity search process. FIG. 13 is a schematic diagram illustrating a conventional technology 1. For example, in the conventional technology 1, by performing clustering, a plurality of pieces of data is classified to a plurality of clusters 1 to 8. The conventional technology 1 compares a position 10 of a query with the region of the clusters 1 to 8 and determines the cluster that includes the query. The conventional technology 1 performs a similarity search process by using a query on the data that is included in the determined cluster. In the example illustrated in FIG. 13, because the cluster that includes the query is the cluster 5, the conventional technology 1 performs the similarity search process on the data, as the target, that is included in the cluster 5.

However, as described in the conventional technology 1, if the search target is limited to a single cluster, the data that is originally similar may sometimes be excluded and the accuracy of the similarity search may possibly be degraded. In contrast, there is a conventional technology 2.

FIG. 14 is a schematic diagram illustrating the conventional technology 2. In the conventional technology 2, the cluster overlapped with a region 10a centered on the position 10 of the query is determined. The conventional technology 2 performs the similarity search process by using a query on the data that is included in the determined cluster. In the example illustrated in FIG. 14, because the clusters overlapped with the region 10a are clusters 5, 6, and 8, the conventional technology 2 performs the similarity search process on the data, as the target, that is included in the clusters 5, 6, and 8. These related-art example are described, for example, in Japanese Laid-open Patent Publication No. 2009-294855, WO Publication No. 2016/001998, Japanese Laid-open Patent Publication No. 2014-146207, Japanese National Publication of International Patent Application No. 2007-521565, Japanese Laid-open Patent Publication No. 2004-86538 and U.S. Patent Application Publication No. 2005/0171972.

However, in the conventional technologies described above, there is a problem in that it is not possible to appropriately set a search target of a query at a low calculation cost.

For example, in the conventional technology 2 described above, the accuracy of the similarity search can be improved when compared with the conventional technology 1; however, because an amount of data targeted for the similarity search is increased in units of clusters, a calculation cost is increased.

### SUMMARY

According to an aspect of an embodiment, a non-transitory computer-readable recording medium has stored therein a data search program that causes a computer to execute a process including: first specifying a first cluster that is closest to an input query based on a plurality of clusters formed by a plurality of pieces of clustered target data that have been subjected to bit vectorization and based on the input query that has been subjected to bit vectorization; second specifying another cluster that is different from the first cluster that includes the target data and whose distance from the input query is within the first distance, by using a first distance indicating a distance from the position of the input query to the center of the first cluster; extracting the target data that belongs to the other cluster and whose distance from the input query is within the first distance or the target data that belongs to the other cluster and whose distance from the center of the other cluster is greater than a second distance; and searching the target data similar to the input query from the target data that belongs to the first cluster and the target data that is extracted from the other cluster.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a schematic diagram illustrating an example of a process performed by a data search device according to an embodiment;

FIG. 2 is a block diagram illustrating an example of the data search device according to the embodiment;

FIG. 3 is a schematic diagram illustrating an example of the data structure of a data-to-be-searched management table;

FIG. 4 is a schematic diagram illustrating an example of the data structure of a compressibility function table;

FIG. 5 is a schematic diagram illustrating an example of the data structure of a cluster management table;

FIG. 6 is a schematic diagram illustrating an example of the data structure of a data distribution management table;

FIG. 7 is a schematic diagram illustrating an example of the data structure of a sort table;

FIG. 8 is a schematic diagram illustrating an example of various kinds of variables;

FIG. 9 is a flowchart (1) illustrating the flow of a process performed by the data search device;

FIG. 10 is a flowchart (2) illustrating the flow of a process performed by the data search device;

FIG. 11 is a schematic diagram illustrating an example of expected values of the data search device according to the embodiment;

FIG. 12 is a block diagram illustrating the hardware configuration of a computer;

FIG. 13 is a schematic diagram illustrating a conventional technology 1; and

FIG. 14 is a schematic diagram illustrating a conventional technology 2.

### DESCRIPTION OF EMBODIMENTS

Preferred embodiments of the present invention will be explained with reference to accompanying drawings. Furthermore, the present invention is not limited to the embodiment.

A data search device according to the embodiment previously clusters data to be searched and obtains not only the cluster belonging to query data but also the cluster that is present in the neighborhood of the query data. In a description below, the cluster belonging to the query data is referred to as a first cluster. Furthermore, the cluster other than the first cluster that is present in the neighborhood of the query data is referred to as a neighborhood cluster.

The data search device performs a similarity search process of searching for data similar to the query data on not only the data to be searched belonging the first cluster but also the data to be searched belonging to a neighborhood cluster. Here, regarding the data to be searched belonging to the neighborhood cluster, the data search device determines whether a possibility of belonging to the neighborhood of the query data is high and performs the similarity search process on only the data to be searched in which the possibility is high.

For example, the data search device uses the distance between the data to be searched in the neighborhood cluster and the center of this neighborhood cluster. If the subject distance is greater than a threshold that is obtained from the query data and the first cluster, the data search device determines that there is a high possibility that the subject data to be searched is present in the neighborhood of the query data.

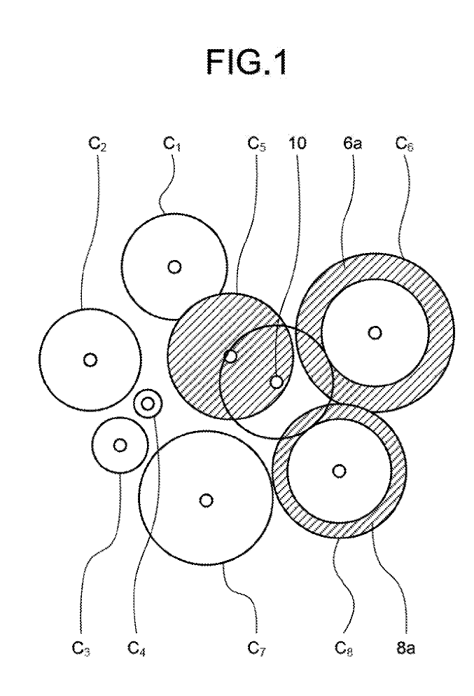

FIG. 1 is a schematic diagram illustrating an example of a process performed by a data search device according to an embodiment. In the example illustrated in FIG. 1, it is assumed that a plurality of pieces of data to be searched is classified into clusters C₁ to C₈. Furthermore, it is assumed that the position of the query data is the position 10 and the first cluster is the cluster C₅. It is assumed that the neighborhood clusters are the clusters C₆ and C₈. Furthermore, it is assumed that, it is determined that, between the clusters C₆ and C₈ that are neighborhood clusters, there is a high possibility that the data to be searched included in areas 6a and 8a is present in the neighborhood of the query data. In this case, the data search device performs the similarity search process on the data to be searched belonging to the cluster C₅ and the data to be searched belonging to the areas 6a and 8a. As described above, when the similarity search process is performed on, in addition to the first cluster, the data to be searched belonging to the neighborhood cluster, the similarity search is performed on only a part of the data to be searched included in the neighborhood cluster in which the possibility of presence in the neighborhood of the query data is high. Thus, it is possible to appropriately set the search target of the query.

Furthermore, if the distance between the center of a cluster and all of the data to be searched in the neighborhood cluster is calculated and if it is determined whether there is a high possibility of presence in the neighborhood of the query data, there may be a case in which a calculation cost becomes large.

Accordingly, the data search device according to the embodiment compresses the feature value of the data to be searched into a bit vector represented by 0 and 1 and reduces a calculation cost. The data search device holds all of the pieces of the data to be searched in a state in which the data is compressed into a bit vector and calculates each of the distances by using a bit vector. By compressing the data to be searched into the bit vectors, the distance between the data to be searched and the center of the cluster is rounded to a discrete value and the distance between a plurality of pieces of the data to be searched and the center of the cluster have the same value. Consequently, for example, there is only a need to determine, performed on only some pieces of data to be searched, whether there is a high possibility of presence in the neighborhood of the query data, which makes it possible to perform the similarity search described above at a lower calculation cost.

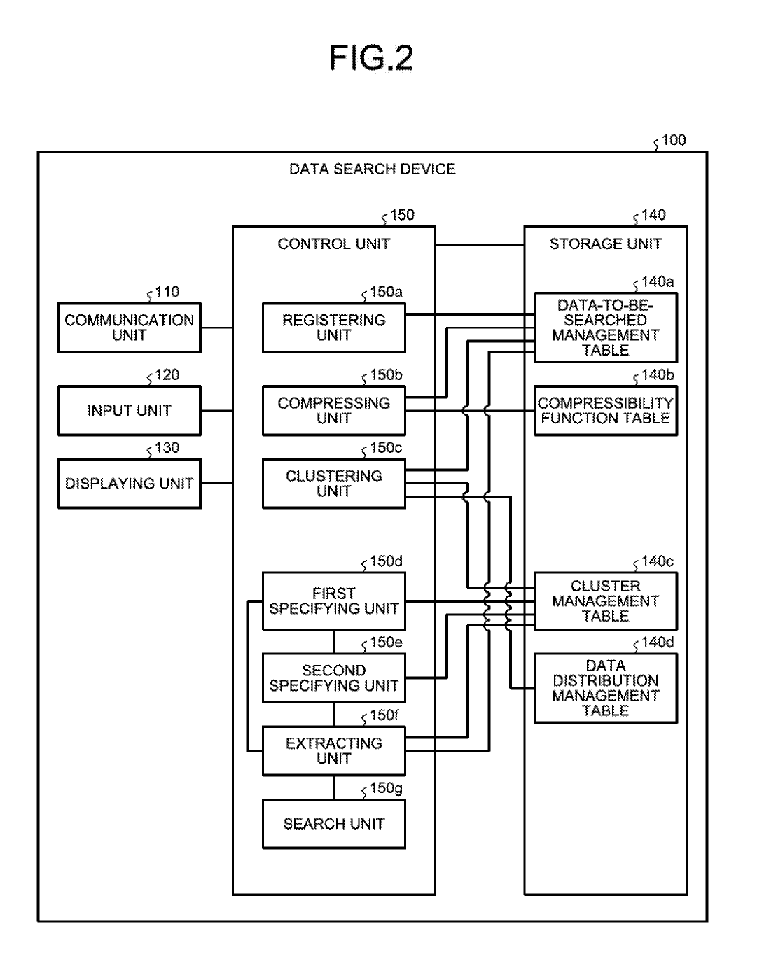

FIG. 2 is a block diagram illustrating an example of the data search device according to the embodiment. As illustrated in FIG. 2, a data search device 100 includes a communication unit 110, an input unit 120, a displaying unit 130, a storage unit 140, and a control unit 150.

The communication unit 110 is a processing unit that performs data communication with another external device (not illustrated) via a network. The communication unit 110 corresponds to a communication device, such as a network interface card (NIC), or the like.

The input unit 120 is an input device that inputs various kinds of information to the data search device 100. The input unit 120 corresponds to a keyboard, a mouse, a touch panel, or the like.

The displaying unit 130 is a display device that displays information output from the control unit 150. The displaying unit 130 corresponds to a liquid crystal display, a touch panel, or the like.

The storage unit 140 includes a data-to-be-searched management table 140a, a compressibility function table 140b, a cluster management table 140c, and a data distribution management table 140d. The storage unit 140 corresponds to, for example, a semiconductor memory device, such as a random access memory (RAM), a read only memory (ROM), a flash memory, or the like or a storage device, such as a hard disk, an optical disk, or the like.

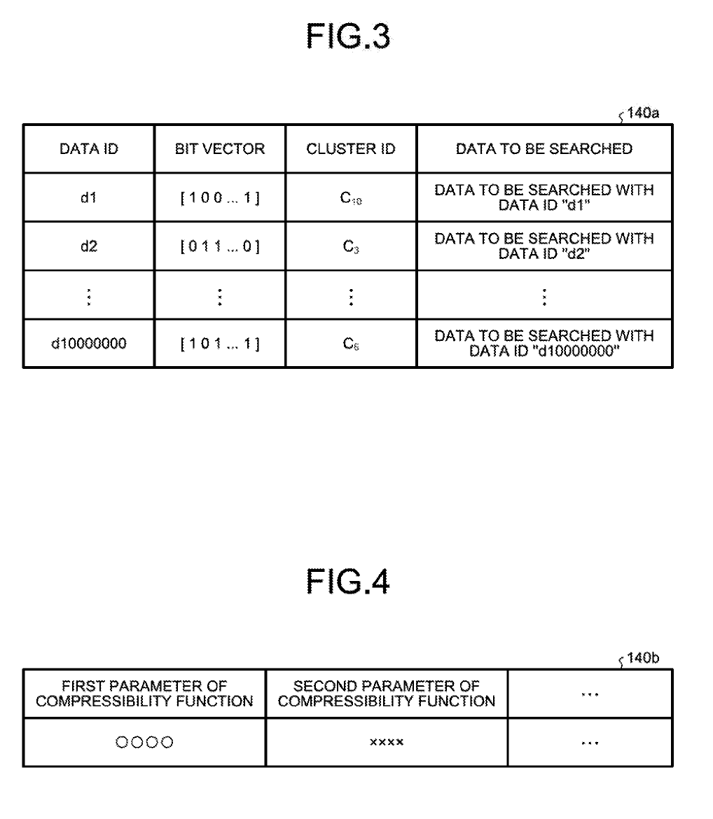

The data-to-be-searched management table 140a is a table that holds various kinds of information related to the data to be searched. FIG. 3 is a schematic diagram illustrating an example of the data structure of the data-to-be-searched management table. As illustrated in FIG. 3, the data-to-be-searched management table 140a associates the data ID (identification), the bit vector, the cluster ID, and the data to be searched. The data ID is information for uniquely identifying the data to be searched. The bit vector is obtained by performing bit vectorization on the feature value extracted from the data to be searched. The cluster ID is information for uniquely identifying the cluster to which the data to be searched belongs.

The compressibility function table 140b is a table that stores therein each of the parameters of the compressibility function used when the feature value of the data to be searched is compressed into a bit vector. FIG. 4 is a schematic diagram illustrating an example of the data structure of the compressibility function table. As illustrated in FIG. 4, the compressibility function table 140b includes a first parameter and a second parameter of the compressibility function. FIG. 4 illustrates, as an example, the first and the second parameters; however, another parameter may also be stored in the compressibility function table 140b.

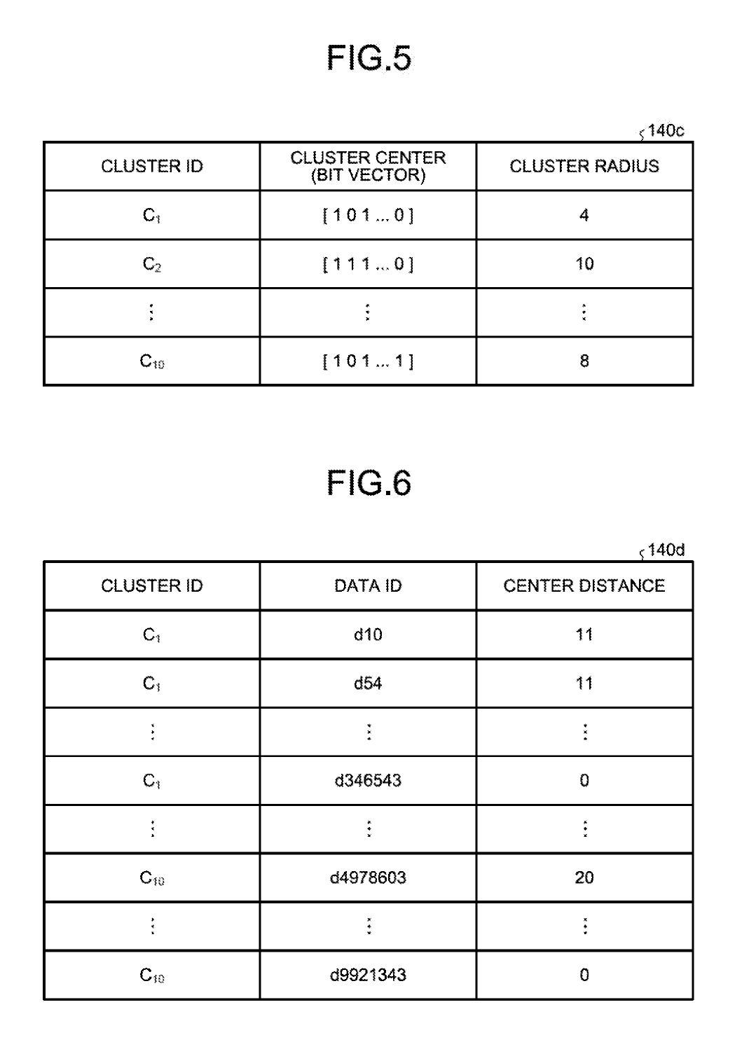

The cluster management table 140c is a table that holds various kinds of information related to the clusters in each of which the data to be searched is classified. FIG. 5 is a schematic diagram illustrating an example of the data structure of the cluster management table. As illustrated in FIG. 5, the cluster management table 140c associates the cluster ID, the cluster center, and the cluster radius. The cluster ID is information for uniquely identifying the cluster. The cluster center is information obtained by compressing the center position of the cluster into a bit vector. The cluster radius indicates the radius of the cluster.

The data distribution management table 140d is a table that holds information related to the relationship between a cluster and the data to be searched that belongs to the cluster. FIG. 6 is a schematic diagram illustrating an example of the data structure of the data distribution management table. As illustrated in FIG. 6, the data distribution management table 140d associates the cluster ID, the data ID, and the center distance. The cluster ID is information for uniquely identifying the cluster. The data ID is information for uniquely identifying the data. The center distance is information indicating the distance between the center of a cluster and the data to be searched.

A description will be given here by referring back to FIG. 2. The control unit 150 includes a registering unit 150a, a compressing unit 150b, a clustering unit 150c, a first specifying unit 150d, a second specifying unit 150e, an extracting unit 150f, and a search unit 150g. The control unit 150 corresponds to, for example, an integrated device, such as an application specific integrated circuit (ASIC), a field programmable gate array (FPGA), or the like. Furthermore, the control unit 150 corresponds to, for example, an electronic circuit, such as a CPU, a Micro Processing Unit (MPU), or the like.

If the registering unit 150a is a processing unit that accepts the data to be searched that is targeted for registration, the registering unit 150a registers the accepted data to be searched in the data-to-be-searched management table 140a. For example, the registering unit 150 may also accept the data to be searched targeted for registration from an external device in a network via the communication unit 110 or may also accept the data to be searched from the input unit 120.

The registering unit 150a allocates a unique data ID to the data to be searched, associates the data ID with the data to be searched, and registers the associated data in the data-to-be-searched management table 140a.

The compressing unit 150b is a processing unit that calculates a bit vector obtained by compressing the feature value of each of the pieces of the data to be searched registered in the data-to-be-searched management table 140a. For example, the compressing unit 150b extracts the feature value from each of the pieces of the data to be searched and substitutes the feature value for the compressibility function, thereby compressing the feature value into the bit vector. The compressing unit 150b uses, as the parameter of the compressibility function, the first parameter, the second parameter, or the like registered in the compressibility function table 140b. The compressing unit 150b registers the bit vector of the feature value in the data-to-be-searched management table 140a.

Any feature value may also be used for the feature value of the data to be searched. For example, if the data to be searched is image information, the feature value is a color of an image, the brightness, a contour, an eigenvalue, an eigenvector, the shape of an imaged object, the number of objects, or the like. If the data to be searched is sound information, the feature value is a frequency spectrum, a sound volume, or the like.

Furthermore, the compressing unit 150b extracts the feature value from each of the pieces of the data to be searched and specifies, by using the extracted feature value, the first parameter and the second parameter of the compressibility function. The compressing unit 150b registers the information on the specified first parameter and the second parameter in the compressibility function table 140b.

The process of calculating a bit vector performed by the compressing unit 150b described above is an example and a bit vector may also be calculated by another known technology. For example, a bit vector may also be calculated by using the technology described in Japanese Laid-open Patent Publication No. 2015-170217.

The clustering unit 150c is a processing unit that clusters each of the pieces of the data to be searched registered in the data-to-be-searched management table 140a. The clustering unit 150c classifies each of the pieces of the data to be searched into each of the clusters by using a hierarchical method, such as a minimum distance method, or the like, or a non-hierarchical method, such as the k-means method, or the like. The clustering unit 150c registers, based on the relationship between the cluster and the data to be searched belonging to this cluster, the cluster ID associated with the data ID in the data-to-be-searched management table 140a.

The clustering unit 150c obtains the cluster center and the cluster radius for each cluster. The clustering unit 150c associates the cluster ID, the cluster center, and the cluster radius and registers the associated data in the cluster management table 140c.

The clustering unit 150c calculates, regarding all of the pieces of the data to be searched registered in the data-to-be-searched management table 140a, the center distance between the data to be searched and the cluster center of the cluster to which the subject data to be searched belongs. The clustering unit 150c registers, based on the calculation result, the cluster ID, the data ID, and the center distance in the data distribution management table 140d.

Incidentally, if the clustering unit 150c, the first specifying unit 150d, the second specifying unit 150e, the extracting unit 150f, or the search unit 150g, which will be described later, calculates the distance by using a bit vector, the subject unit uses the Hamming distance.

The bit vector is, as illustrated in FIG. 3, FIG. 5, or the like, the vector constituted by 0 or 1. The distance between the two bit vectors can be calculated by using the Hamming distance. The Hamming distance is a value obtained by taking two binary exclusive ORs and summing the number of bits that are set. It can be said that the distance between the two bit vectors is closer as the Hamming distance is smaller and both are similar data. For example, the Hamming distance between the bit vectors [000110110] and [110110110] becomes 2.

In the embodiment, a Hamming distance d between data x and data y is referred to as Equation (1) by using the Hamming distance output function hamming distance (x,y).

d=hamming₁₃ distance(x,y) (1)

The first specifying unit 150d is a processing unit that specifies the first cluster closest to the query data from among the plurality of clusters that have been subjected to clustering by the clustering unit 150c. The first specifying unit 150d acquires the query data via the communication unit 110 or the input unit 120.

Here, if the query data is x, the i^{th} cluster is Cᵢ, and the center of the i^{th} cluster is c₁, a distance dᵢ(x) between the query data and the center of the i^{th} cluster can be calculated by using Equation (2).

d₁(x)=hamming_distance(x,c₁) (2)

The first specifying unit 150d refers to the cluster management table 140c, calculates a distance dᵢ(x) for each cluster based on Equation (2), and specifies the cluster with the smallest distance dᵢ(x) as the first cluster. The distance dₘᵢₙ between the first cluster C_{1sT} and the query data is defined by Equation (3) and Equation (4). The first specifying unit 150d outputs the cluster ID of the first cluster to the extracting unit 150f. Furthermore, the first specifying unit 150d outputs the distance dₘᵢₙ and the information on the distance dᵢ(x) of each of the clusters to the second specifying unit 150e.

$$\begin{matrix}1 st = {{arg micC}_{i}}_{i = 1 to I} & ( 3 ) \\ {d}_{min} = {d}_{1 st} ( x ) & ( 4 )\end{matrix}$$

The second specifying unit 150e is a processing unit that specifies a neighborhood cluster from the clusters other than the first cluster by using the distance dₘᵢₙ. In the following, an example of a process performed by the second specifying unit 150e will be described. The second specifying unit 150e obtains a neighborhood cluster based on a neighborhood threshold θ_{hd i} and the cluster radius Rᵢ of each of the clusters. The second specifying unit 150e acquires the information on the cluster radius Rᵢ from the cluster management table 140c.

Here, the neighborhood threshold indicates whether each of the clusters is present in the neighborhood of the first cluster and the value of neighborhood threshold differs in accordance with each of the clusters. It can be said that, as the value of the neighborhood threshold of the cluster is smaller, the subject cluster is present in the neighborhood of the first cluster. In contrast, it can be said that the value of the neighborhood threshold of the cluster is greater, the subject cluster is away from the first cluster.

The second specifying unit 150e calculates the neighborhood threshold θᵢ of the cluster Cᵢ based on Equation (5).

θ=dᵢ(x)−dₘᵢₙ (5)

If the value of the neighborhood threshold θᵢ is smaller than cluster radius Rᵢ, the second specifying unit 150e specifies the cluster Cᵢ as the neighborhood cluster. Namely, the second specifying unit 150e specifies the i^{th} cluster Cᵢ that satisfies the condition described below as the neighborhood cluster. The second specifying unit 150e outputs the cluster ID of the neighborhood cluster to the extracting unit 150f.

Rᵢ>θᵢ (condition)

The extracting unit 150f is a processing unit that extracts, from the data-to-be-searched management table 140a, the data to be searched that is compared with the query data from among the pieces of the data to be searched belonging to the neighborhood cluster.

Furthermore, the extracting unit 150f extracts, from the data-to-be-searched management table 140a, the data to be searched belonging to the first cluster based on the cluster ID of the first cluster acquired from the first specifying unit 150d. The extracting unit 150f outputs the data to be searched belonging to the first cluster to the search unit 150g.

In the following, a description will be given of a process in which the extracting unit 150f extracts, from the data-to-be-searched management table 140a, the data to be searched that is compared with the query data from among the pieces of data to be searched that belong to the neighborhood cluster. In a description below, the data to be searched compared with the query data from among the pieces of the data to be searched belonging to the neighborhood cluster is appropriately referred to as neighborhood data. The extracting unit 150f outputs the neighborhood data to the search unit 150g.

If the distance between the j^{th} data to be searched yᵢⱼ belonging to the neighborhood cluster Cᵢ and the center cᵢ of the neighborhood cluster is equal to or greater than the neighborhood threshold θ₁, the extracting unit 150f extracts the data to be searched yᵢⱼ as the neighborhood data. Namely, this means that the extracting unit 150f extracts the data to be searched yᵢⱼ that satisfies Equation (6) as the neighborhood data.

hamming_distance(yᵢⱼ,cᵢ)≧θ₁ (6)

At this point, if the extracting unit 150f performs a process of determining whether each of all of the pieces of the data to be searched in the neighborhood cluster is the neighborhood data, a calculation cost may sometimes be increased. Thus, by extracting the neighborhood data by using the method described below, the extracting unit 150f can reduce the calculation cost.

Because the data search device 100 according to the embodiment compresses the feature value of the data to be searched into a bit vector, the distance hamming distance (yᵢⱼ,cᵢ) between the data to be searched and the cluster center is rounded to a discrete value. Thus, after having determined whether certain data to be searched is the neighborhood data, the extracting unit 150f diverts already-performed determination result to the data to be searched with the same distance.

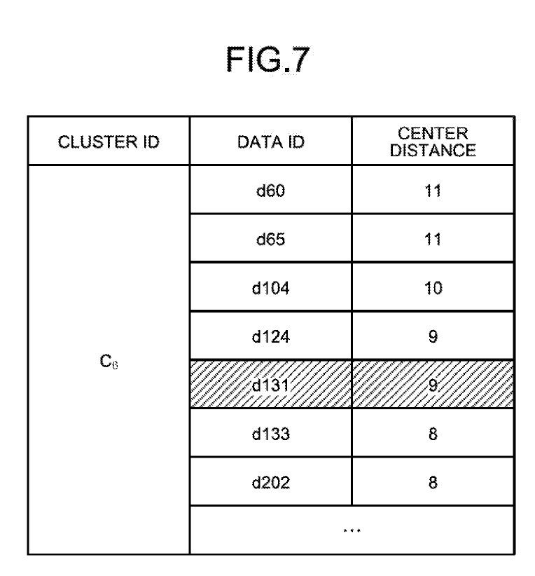

For example, the extracting unit 150f creates a sort table by sorting, in descending order, the neighborhood clusters by using the value of the distance hamming_distance(yᵢⱼ,cᵢ) between the data to be searched and the cluster center. FIG. 7 is a schematic diagram illustrating an example of the data structure of a sort table. As illustrated in FIG. 7, the sort table associates the cluster ID, the data ID, and the center distance. Here, as an example, the cluster ID of the neighborhood cluster is set to C₆.

For example, if the neighborhood threshold θ₆ is “9”, the extracting unit 150f specifies the record of the center distance that matches the neighborhood threshold θ₆ of “9” by performing match determination in ascending order of the center distances without comparing the magnitudes. In the example illustrated in FIG. 7, the extracting unit specifies the record of the data ID “d131”. The extracting unit 150f extracts the data IDs of the specified record and the record located above the specified record as pieces of the neighborhood data. By performing the same process on the other neighborhood clusters, the extracting unit 150f can reduce an amount of calculation and extract neighborhood data.

The search unit 150g is a processing unit that searches for data to be searched similar to the query data. The search unit 150g acquires, from the extracting unit 150f, the data to be searched belonging to the first cluster and the neighborhood data. As described above, the neighborhood data is the data to be searched that belongs to the neighborhood cluster and that is determined by the extracting unit 150f to be compared with the query data from among the pieces of the data to be searched.

The search unit 150g accepts the query data via the communication unit 110 or the input unit 120. The search unit 150g obtains the bit vector of the query data by, similarly to the compressing unit 150b, compressing the compressibility function of the feature value of the query data.

The search unit 150g compares the query data with each of the pieces of the data to be searched and calculates the distance between the query data and the data to be searched. The search unit 150g outputs the data to be searched in the order in which the distance with the query data is small. Furthermore, the search unit 150g may also sort the pieces of the data to be searched in the order in which the distance with the query data is small and output a part of higher ranked data to be searched as the search result.

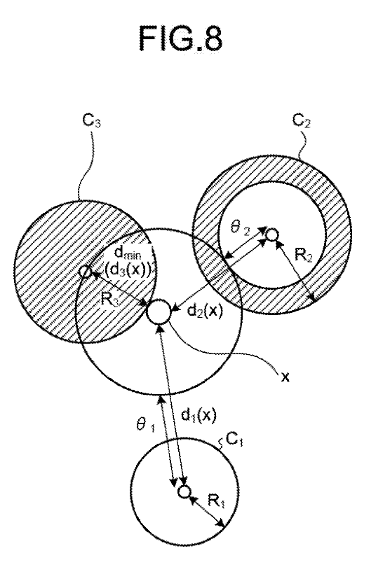

In the following, the various kinds of variables described above are substituted and indicated. FIG. 8 is a schematic diagram illustrating an example of various kinds of variables. In the example illustrated in FIG. 8, if the distance d₃(x) is the minimum from among the distances d₁(x) to d₃(x) between the center of the clusters C₁ to C₃ and the query data x, the cluster C₃ corresponds to the first cluster and the distance d₃(x) corresponds to dₘᵢₙ.

Because the value of the neighborhood threshold θ₂ is smaller than the cluster radius R₂, the cluster C₂ becomes the neighborhood cluster. Because the value of the neighborhood threshold θ₁ is greater than the cluster radius R₁, the cluster C₁ does not become the neighborhood cluster.

The search unit 150g performs a comparison of the query data x with, as a target, the data to be searched belonging to the cluster C₃ and the neighborhood data belonging to the cluster C₂. The neighborhood data belonging to the cluster C₂ is the data to be searched in which the center distance of the cluster C₂ is equal to or greater than the neighborhood threshold θ₂ from among the pieces of the data to be searched belonging to the cluster C₂ .

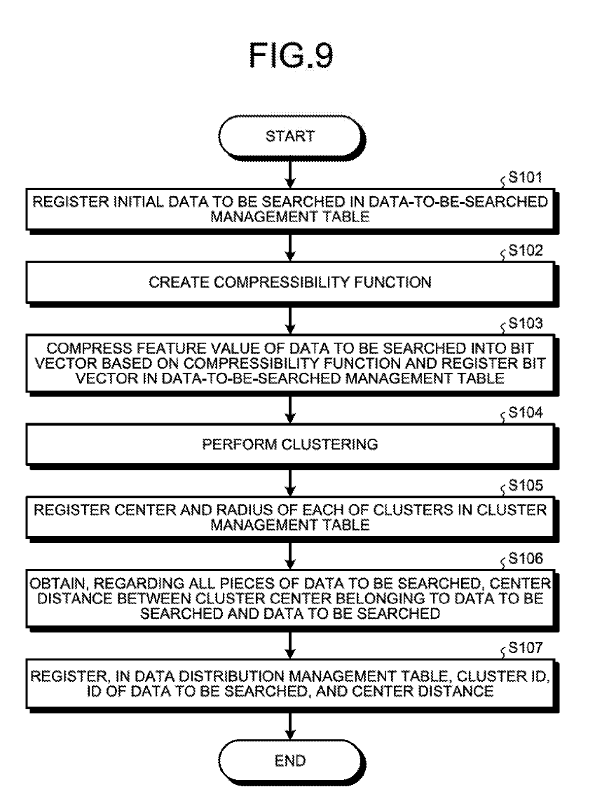

In the following, the flow of the process performed by the data search device 100 according to the embodiment will be described. FIG. 9 is a flowchart (1) illustrating the flow of a process performed by the data search device. As illustrated in FIG. 9, the registering unit 150a in the data search device 100 registers the initial data to be searched in the data-to-be-searched management table 140a (Step S101).

The compressing unit 150b in the data search device 100 creates a compressibility function (Step S102). The compressing unit 150b compresses the feature value of the data to be searched into a bit vector based on the compressibility function and registers the bit vector in the data-to-be-searched management table 140a (Step S103).

The clustering unit 150c in the data search device 100 performs clustering (Step S104). The clustering unit 150c registers the center and the radius of each of the clusters in the cluster management table 140c (Step S105).

The clustering unit 150c obtains, regarding all of the pieces of the data to be searched, the center distance between the cluster center belonging to the data to be searched and the data to be searched (Step S106). The clustering unit 150c stores, in the data distribution management table 140d, the cluster ID, the data ID, and the center distance (Step S107).

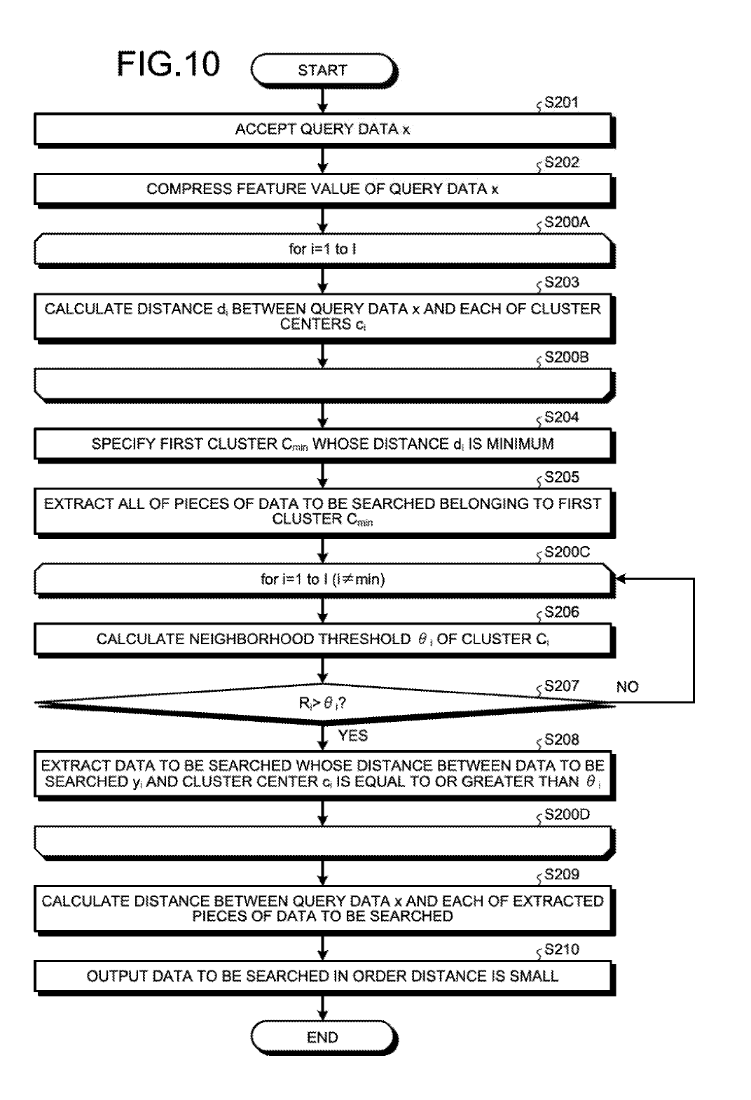

FIG. 10 is a flowchart (2) illustrating the flow of a process performed by the data search device. As illustrated in FIG. 10, the search unit 150g in the data search device 100 accepts the query data x (Step S201) and compresses the feature value of the query data x (Step S202).

The data search device 100 repeatedly performs the process at Steps S200A to S200B by changing the value of i from 1 to I. I is a predetermined value. The first specifying unit 150d in the data search device 100 calculates the distance dᵢ between the query data x and each of the cluster centers cᵢ (Step S203).

The first specifying unit 150d specifies the first cluster Cₘᵢₙ whose distance dᵢ is the minimum (Step S204). The extracting unit 150f in the data search device 100 extracts all of the pieces of the data to be searched belonging to the first cluster Cₘᵢₙ (Step S205).

The data search device 100 repeatedly performs the process at Step S200C to S200D by changing the value of i from 1 to I (excluding min). The second specifying unit 150e in the data search device 100 calculates the neighborhood threshold θᵢ of the cluster Cᵢ (Step S206).

The second specifying unit 150e determines whether Rᵢ>θᵢ is satisfied (Step S207). If Rᵢ>θᵢ is not satisfied (No at Step S207), the second specifying unit 150e proceeds to Step S200C. In contrast, if Rᵢ>θᵢ is satisfied (Yes at Step S207), the second specifying unit 150e proceeds to Step 5208.

The extracting unit 150f extracts the data to be searched in which the distance between the data to be searched yᵢ and the cluster center cᵢ is equal to or greater than θᵢ (Step S208). The search unit 150g calculates the distance between the query data x and each of the extracted pieces of the data to be searched (Step S209). The search unit 150g outputs the data to be searched in the order the distance is small (Step S210).

In the following, the effect of the data search device 100 according to the embodiment will be described. The data search device 100 performs the similarity search process on, in addition to the first cluster that is closest to the query data, the data to be searched belonging to the neighborhood cluster. If the data search device 100 performs the similarity search process on the data to be searched in the neighborhood cluster, the data search device 100 performs the similarity search only some of data to be searched in the neighborhood cluster in which the possibility of presence in the neighborhood of the query data is high. Thus, it is possible to appropriately set the search target of the query. Furthermore, the calculation cost can also be reduced because the similarity search process is not performed on the data to be searched in the neighborhood cluster in which the possibility of presence in the neighborhood of the query data is low.

Furthermore, after having determined whether certain data to be searched is the neighborhood data, the data search device 100 diverts already-performed determination result to the pieces of data to be searched that have the same distance; therefore, the data search device 100 can reduce the number of determinations and can thus further reduce the calculation cost.

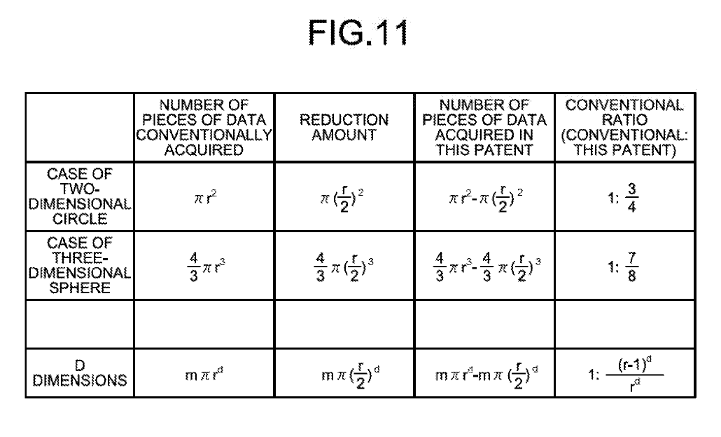

Subsequently, the number of pieces of the data to be searched compared with the query data by a conventional technology is compared with the number of pieces of the data to be searched compared with the query data by the data search device 100 according to the embodiment. FIG. 11 is a schematic diagram illustrating an example of expected values of the data search device according to the embodiment.

For example, if it is assumed that a cluster is a two-dimensional circle, all of the pieces of the data to be searched in the subject cluster belong to within an area (πr²). The neighborhood threshold varies depending on the state of the cluster or query data; however, it is conceivable that the neighborhood threshold is half of the cluster radius (r/2) on average. Thus, because the area that can be removed is 1/4πr², it is possible to reduce a quarter of the data to be searched per cluster. Because the amount that can be reduced varies depending on the number of dimensions, in FIG. 11, a case of three dimensions and a case of d dimensions are indicated.

In a case of two-dimensions, in the conventional technology, the number of pieces of data to be searched to be acquired is “πr²” and the reduction amount is “π(r/2)²”. The number of pieces of data to be searched acquired by this patent is “πr²−π(r/2)²”. The ratio of the number of pieces of data to be searched acquired by the conventional technology to that acquired by this patent is “1:3/4”.

In a case of three dimensions, in the conventional technology, the number of pieces of data to be searched is “4/3πr³” and the reduction amount is “4/3π(r/2)³”. The number of pieces of data to be searched acquired by this patent is “4/3πr³−4/3π(r/2)³”. The ratio of the number of pieces of data to be searched acquired by the conventional technology to that acquired by this patent is “1:7/8”.

In a case of d dimensions, in the conventional technology, the number of pieces of data to be searched is “mπr^{d}” and the reduction amount is “mπ(r/2)^{d}”. The number of pieces of data to be searched acquired by this patent is “mπr^{d}−mπ(r/2)^{d}”. The ratio of the number of pieces of data to be searched acquired by the conventional technology to that acquired by this patent is “1:(r−1)^{d}/r^{d}”. It is assumed that m is a constant.

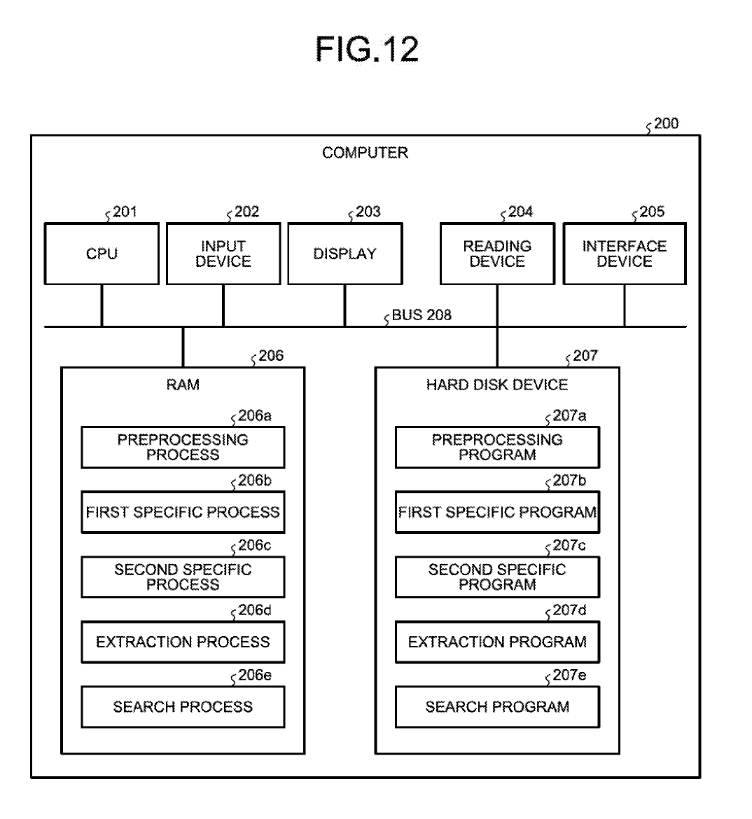

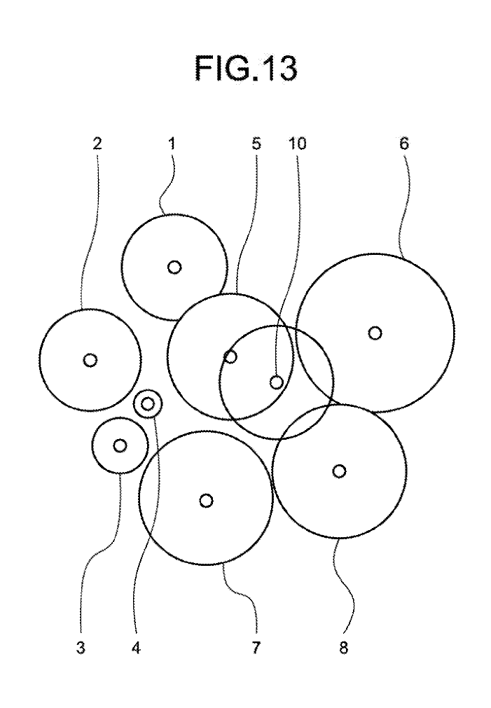

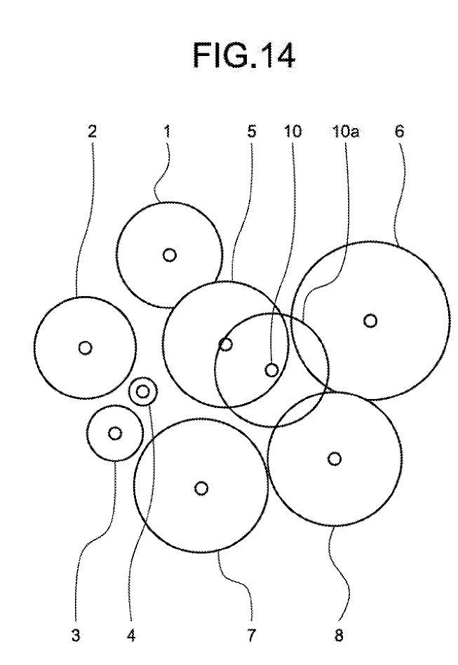

In the following, a description will be given of an example of the hardware configuration of a computer that implements the same function as that performed by the data search device 100 in the embodiment described above. FIG. 12 is a block diagram illustrating the hardware configuration of a computer.

As illustrated in FIG. 12, a computer 200 includes a CPU 201 that executes various kinds of arithmetic processing, an input device 202 that accepts an input of data from a user, and a display 203. Furthermore, the computer 200 includes a reading device 204 that reads a program or the like from a storage medium and an interface device 205 that sends and receives data to and from another computer via a network. Furthermore, the computer 200 includes a RAM 206 that temporarily stores therein various kinds of information and a hard disk device 207. Then, each of the devices 201 to 207 is connected to a bus 208.

The hard disk device 207 includes a preprocessing program 207a, a first specific program 207b, a second specific program 207c, an extraction program 207d, and a search program 207e. The CPU 201 reads the preprocessing program 207a, the first specific program 207b, the second specific program 207c, the extraction program 207d, and the search program 207e and loads the programs in the RAM 206.

The preprocessing program 207a functions as a preprocessing process 206a. The first specific program 207b functions as a first specific process 206b. The second specific program 207c functions as a second specific process 206c. The extraction program 207d functions as an extraction process 206d. The search program 207e functions as a search process 206e.

For example, the process of the preprocessing process 206a corresponds to the process performed by the registering unit 150a, the compressing unit 150b, and the clustering unit 150c. The process of the first specific process 206b corresponds to the process performed by the first specifying unit 150d. The process of the second specific process 206c corresponds to the process performed by the second specifying unit 150e. The process of the extraction process 206d corresponds to the process performed by the extracting unit 150f. The process of the search process 206e corresponds to the process performed by the search unit 150g.

Furthermore, the preprocessing program 207a, the first specific program 207b, the second specific program 207c, the extraction program 207d, and the search program 207e do not need to be stored in the hard disk device 207 from the beginning. For example, each of the programs is stored in a “portable physical medium”, such as a flexible disk (FD), a CD-ROM, a DVD disk, a magneto-optic disk, an IC CARD, or the like, that is to be inserted into the computer 200. Then, the computer 200 may also read and execute each of the programs 207a to 207e.

A part of data in a cluster can be cut out based on distance calculation reduced by bit vectorization and can be included in a search target.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A non-transitory computer-readable recording medium having stored therein a data search program that causes a computer to execute a process comprising:
first specifying a first cluster that is closest to an input query based on a plurality of clusters formed by a plurality of pieces of clustered target data that have been subjected to bit vectorization and based on the input query that has been subjected to bit vectorization;
second specifying another cluster that is different from the first cluster that includes the target data and whose distance from the input query is within the first distance, by using a first distance indicating a distance from the position of the input query to the center of the first cluster;
extracting the target data that belongs to the other cluster and whose distance from the input query is within the first distance or the target data that belongs to the other cluster and whose distance from the center of the other cluster is greater than a second distance; and
searching the target data similar to the input query from the target data that belongs to the first cluster and the target data that is extracted from the other cluster.

2. The non-transitory computer-readable recording medium according to claim 1, the process further comprising calculating the second distance by subtracting the first distance from the distance between the center of the other specified cluster and the input query.

3. The non-transitory computer-readable recording medium according to claim 2, wherein the second specifying specifies the cluster whose radius is equal to or greater than the second distance, as the other cluster.

4. The non-transitory computer-readable recording medium according to claim 3, wherein the extracting calculates each of the distances between the plurality of the pieces of the target data belonging to the other cluster and the center of the other cluster by using the Hamming distance, sorts the plurality of the pieces of the target data in accordance with the Hamming distance, and extracts the target data with the distance greater than the second distance based on the sort order without comparing the second distance with the target data having the Hamming distance greater than that of the detected target data when the target data having the same Hamming distance as the second distance is detected.

5. A data search method comprising:
first specifying a first cluster that is closest to an input query based on a plurality of clusters formed by a plurality of pieces of clustered target data that have been subjected to bit vectorization and based on the input query that has been subjected to bit vectorization, using a processor;
second specifying another cluster that is different from the first cluster that includes the target data and whose distance from the input query is within the first distance, by using a first distance indicating a distance from the position of the input query to the center of the first cluster, using the processor;
extracting the target data that belongs to the other cluster and whose distance from the input query is within the first distance or the target data that belongs to the other cluster and whose distance from the center of the other cluster is greater than a second distance, using the processor; and
searching the target data similar to the input query from the target data that belongs to the first cluster and the target data that is extracted from the other cluster, using the processor.

6. The data search method according to claim 5, further comprising calculating the second distance by subtracting the first distance from the distance between the center of the other specified cluster and the input query.

7. The data search method according to claim 5, wherein the second specifies the other cluster includes specifying, as the other cluster, the cluster whose radius is equal to or greater than the second distance.

8. The data search method according to claim 7, wherein the extracting calculates each of the distances between the plurality of the pieces of the target data belonging to the other cluster and the center of the other cluster by using the Hamming distance, sorts the plurality of the pieces of the target data in accordance with the Hamming distance, and extracts the target data with the distance greater than the second distance based on the sort order without comparing the second distance with the target data having the Hamming distance greater than that of the detected target data when the target data having the same Hamming distance as the second distance is detected.

9. A data search device comprising:
a processor that executes a process comprising:
first specifying a first cluster that is closest to an input query based on a plurality of clusters formed by a plurality of pieces of clustered target data that have been subjected to bit vectorization and based on the input query that has been subjected to bit vectorization;
second specifying another cluster that is different from the first cluster that includes the target data and whose distance from the input query is within the first distance, by using a first distance indicating a distance from the position of the input query to the center of the first cluster;
extracting the target data that belongs to the other cluster and whose distance from the input query is within the first distance or the target data that belongs to the other cluster and whose distance from the center of the other cluster is greater than a second distance; and
searching the target data similar to the input query from the target data that belongs to the first cluster and the target data that is extracted from the other cluster.

10. The data search device according to claim 9, the process further comprising calculating the second distance by subtracting the first distance from the distance between the center of the other specified cluster and the input query.

11. The data search device according to claim 10, wherein the second specifying specifies the cluster whose radius is equal to or greater than the second distance, as the other cluster.

12. The data search device according to claim 11, wherein the extracting calculates each of the distances between the plurality of the pieces of the target data belonging to the other cluster and the center of the other cluster by using the Hamming distance, sorts the plurality of the pieces of the target data in accordance with the Hamming distance, and extracts the target data with the distance greater than the second distance based on the sort order without comparing the second distance with the target data having the Hamming distance greater than that of the detected target data when the target data having the same Hamming distance as the second distance is detected.
